(19) United States
(12) Patent Application Publication
(10) Pub. No.: US 2006/0278181 A1
(43) Pub. Date: Dec. 14, 2006

(54) INTERNAL COMBUSTION ENGINE WITH FREEWHEELING MECHANISM

(76) Inventor: Gile Jun Yang Park, Burnaby (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/422,812

(22) Filed: Jun. 7, 2006

Related U.S. Application Data
(63) Continuation of application No. 11/149,328, filed on Jun. 10, 2005, now abandoned.

(51) Int. Cl. F02B 75/18

(52) U.S. Cl. 123/52.4

(57) ABSTRACT

A four stroke internal combustion engine having two or more crankshafts, the crankshafts being separated by one or more freewheeling mechanisms so that when the engine is idling or not delivering full power, the freewheeling mechanism(s) enables one or more of the crankshafts with accompanying pistons to idle, thereby conserving fuel.

### FIELD OF THE INVENTION

The invention relates to a novel internal combustion engine. More particularly, this invention pertains to an engine which incorporates a freewheeling mechanism which enables one or more of the pistons to be deactivated in certain operating conditions.

### BACKGROUND OF THE INVENTION

In a conventional internal combustion engine, engine wear is reduced and operational efficiency and fuel consumption are improved if engine vibration is minimized, or some of the pistons can be deactivated at certain times when full power is not required. Vibration is reduced in an engine that is dynamically balanced, but it is difficult to dynamically balance a conventional engine which has only one crankshaft and four, six or eight pistons firing in sequence. Balance can be improved if the engine has more than one crankshaft.

In a conventional internal combustion engine, the speed of the engine is measured in rotations per minute (“rpm”) of the crankshaft. Operating an engine at higher rpm. means that the pistons go through more cycles, all of the moving engine parts go through more operating cycles, and engine wear is increased. Conventional internal sequential piston fired combustion engines with one crankshaft are not dynamically balanced and achieve better balancing when operating at higher rpm than lower rpm. The higher rpm tends to offset imbalance. An engine which is dynamically balanced by including two crankshafts operates more smoothly at a lower rpm. Operating at a lower rpm is advantageous because it results in less engine wear because less operating cycles are performed. Also, less fuel is consumed.

There are a number of patents which disclose dynamically balanced internal combustion engines. Some examples of patents which disclose matched counter-rotating crankshafts are U.S. Pat. No. 2,200,744 granted to Heinzelmann (“Heinzelmann”), U.S. Pat. No. 2,596,410 granted to Le Grand L. Jordan (“Jordan”), U.S. Pat. No. 3,537,437 granted to Angelo Marius Paul (“Paul”), and U.S. Pat. No. 3,581,628 granted to Thomas V. Williams (“Williams”).

U.S. Pat. No. 5,758,610, granted Jun. 2, 1998 to Gile Jun Yang Park, discloses an air-cooled self-supercharging four stroke internal combustion engine having four pistons which move in unison. There are two downward piston strokes in each four stroke cycle. The downward strokes of the pistons are used to compress the air in the crank case and supercharge the engine by forcing the more air and fuel into the two combustion chambers. Each combustion chamber serves two piston cylinders. The compressed air and fuel mixture is forced into only one combustion chamber during each downward stroke of the pistons. The two combustion chambers are charged with air and fuel on alternating downward piston strokes. The engine is air-cooled by the flow of the combustion intake air which passes through the crank case. At the same time, heat transferred from the engine pre-heats the intake air to improve combustion efficiency. The technology disclosed in U.S. Pat. No. 5,758,610 is incorporated herein by reference.

Honda Motor Company has introduced an Odyssey i-VTEC engine which has a VCM™ mechanism that deactivates three of six cylinders during cruising and deceleration to minimize fuel consumption without compromising performance. When full power is required, the VCM activates all six cylinders.

### SUMMARY OF THE INVENTION

A four stroke internal combustion engine comprising:
an engine block with at least two combustion chambers, corresponding pistons, connecting rods and first and second crankshafts;
a crank case associated with said engine block;
a first intake valve associated with the first cylinder;
a first exhaust valve associated with the first cylinder;
a second intake valve associated with the second cylinder;
a second exhaust valve associated with the second cylinder; and
a freewheeling mechanism installed between the first and second crankshafts, said freewheeling mechanism enabling the first crankshaft to drive the second crankshaft but the second crankshaft not to drive the first crankshaft.

The four stroke internal combustion engine can further comprise an engine governor which controls supply of fuel to the first and second combustion chambers.

The four stroke internal combustion engine can also include:
a first fuel injector associated with the first combustion chamber for injecting fuel directly into the first combustion chamber; and
a second fuel injector associated with the second combustion chamber for injecting fuel directly into the second combustion chamber.

In the four stroke internal combustion engine, the first and second crankshafts can be mounted in the crank case with parallel axes aligned with a longitudinal axis of the engine block, wherein the two crankshafts are geared to each other for synchronized counter-rotation by inter-locking teeth on gears mounted on the two crankshafts and rods connecting the two pistons to the two crankshafts whereby the unitary upward and downward movement of the pistons causes the two crankshafts to rotate.

The four stroke internal combustion engine can also include an arrangement where the first and second crankshafts are in a line and the freewheeling mechanism is positioned between the first and second crankshafts.

The four stroke internal combustion engine can also include two internal combustion engines with two respective freewheeling mechanisms connected to a crown and pinion combination for powering two axles with wheels at the ends of the two axles.

### BRIEF DESCRIPTION OF THE DRAWINGS

FIG. 1 represents a cut-away isometric view of four piston cylinders, two crankshafts and two geared flywheels, of an internal combustion engine utilizing a pair of freewheeling mechanisms, incorporated in the two crankshafts according to the invention.

FIG. 2 represents a front cross-sectional view of two forward piston cylinders, connecting rods and crankshafts, of an air cooled internal combustion engine utilizing two freewheeling mechanisms according to the invention.

FIG. 3 represents a front cross-sectional view of two rear pistons with two connecting rods and two crankshafts with two freewheeling mechanisms installed on the two crankshafts according to the invention.

FIG. 4 represents an elevation view of two disconnected crankshafts, two pairs of pistons and two flywheels mounted in linear series with a freewheeling mechanism located between the two disconnected crankshafts, pistons and flywheels according to the invention

FIG. 5 illustrates an elevation view similar to FIG. 4 with the engine components connected.

FIG. 6, which appears on the same page as FIG. 1, illustrates an isometric view of two engines with respective freewheeling mechanisms connected to a crown and pinion gear assembly connected by axle to a vehicle wheel.

### DETAILED DESCRIPTION OF THE PREFERRED EMBODIMENT

The invention relates in one aspect to a four stroke internal combustion engine with four pistons arranged in side-by-side pairs. The four piston strokes repeat themselves in the following sequential order: exhaust stroke, intake stroke, compression stroke, and power stroke. The intake and power stroke correspond to downward piston motions, while the compression and exhaust strokes correspond to upwards piston motions.

A freewheeling mechanism is a one-way drive mechanism. Automotive Mechanics, William H. Crouse, 6th Edition, McGraw-Hill, Chapter 31, discloses a freewheeling mechanism. In a freewheeling mechanism, positive drive is provided by a first shaft or wheel on a second shaft or wheel. However, the second shaft or wheel cannot drive the first wheel or shaft. When the first shaft or wheel is slowed or stopped, the second shaft or wheel “freewheels”, and continues turning. In the context of clutches, or planetary gear sets, the freewheeling mechanism is sometimes described as an overrunning clutch. Freewheeling mechanisms can include centrifugal clutches, bicycle clutches, solenoid clutches, hydraulic clutches, spray clutches and pneumatic clutches.

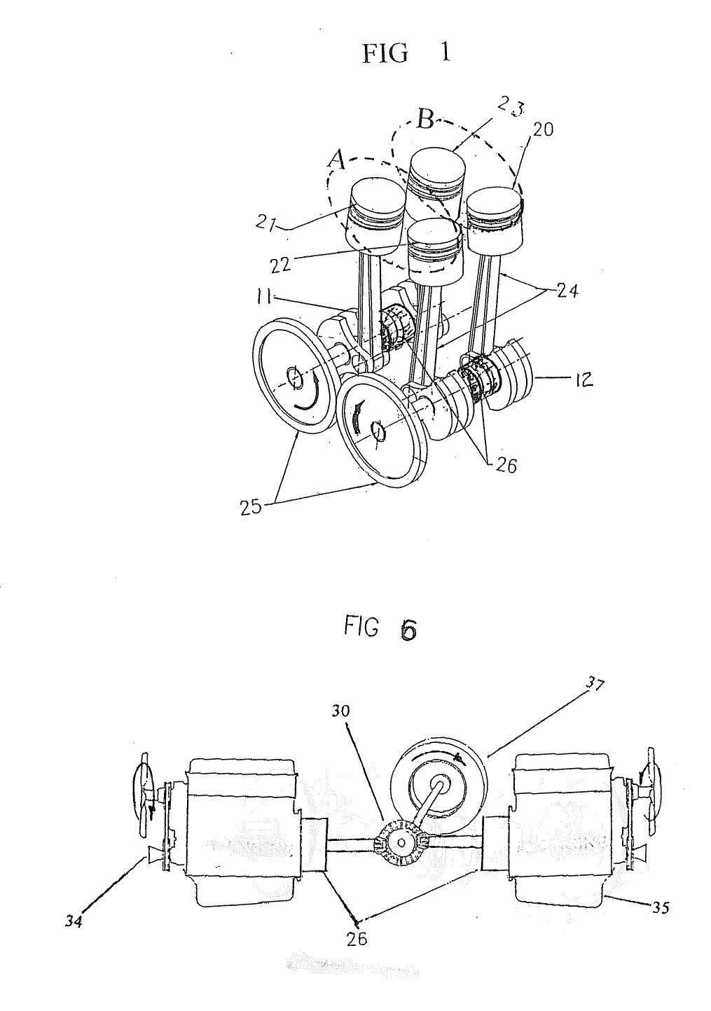

FIG. 1 is a cut-away isometric diagram of four pistons (20, 21, 22 and 23) connected by respective connecting rods (24) to two crankshafts (11,12) with respective flywheels (25) at the front end of each crankshaft (11,12). Two freewheeling mechanisms (26) are located in the central region of the respective crankshafts (11, 12). As seen in FIG. 1, two pistons (20, 22) are located on one side of the longitudinal axis of the engine, while two pistons (21, 23) are located on the opposite side of the longitudinal axis. The respective connecting rods (24) attached to pistons (21, 23) on one side of the engine's longitudinal axis are attached to crankshaft (11) on the same side. Similarly, the respective connecting rods (24) attached to pistons (20, 22) on the other side of the engine's longitudinal axis are attached to crankshaft (12).

According to the invention, the front two pistons (21, 22) denoted by dotted circle A are synchronized to move up and down together. The two rear pistons (20, 23) denoted by the dotted circle B also move up and down together. The two front pistons (21, 22) are constant drive pistons while the two rear pistons (20, 23), because of the two interposed freewheeling mechanisms (26), can be drive pistons, when gasoline is injected into the two rear cylinders, or idle pistons when no gasoline is injected in the rear cylinders. The pair of pistons (21, 23) operate on a stroke cycle that is staggered two strokes from the pair of pistons (20, 22). Consequently, when the two pistons (21, 23) connected to the crankshaft (11) are undergoing an upwards exhaust stroke, the two pistons (20, 22) connected to crankshaft (12) are undergoing an upwards compression stroke, and vice versa. Similarly, when the first pair of pistons are undergoing a downwards intake stroke, the second pair of pistons are undergoing a downwards power stroke.

When the engine is required to deliver full power, gasoline is delivered by a computerized fuel system (not shown) to all four pistons. When the engine is not required to deliver full power, such as when the vehicle is idling or coasting downhill, gasoline is delivered to only the front two pistons (21, 22) and the rear two pistons (20, 23) because of the freewheeling mechanisms (26) are free to idle.

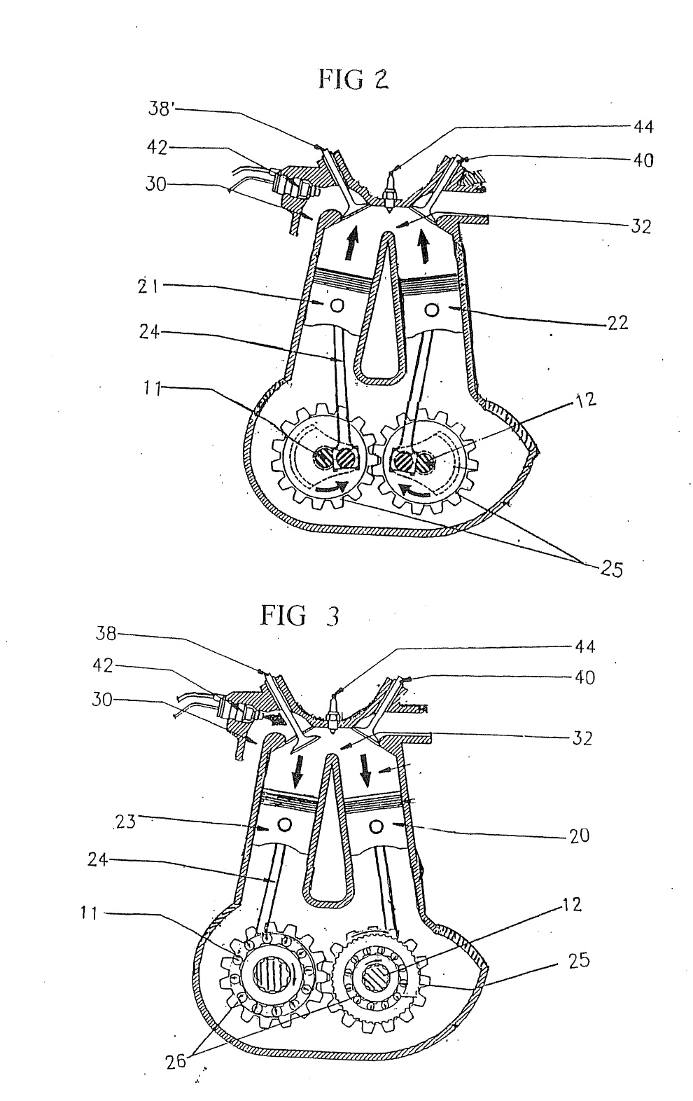

FIG. 2 illustrates a front cross-sectional view through the engine, showing the front pair of pistons (21, 22). The two pistons (21, 22) are positioned inside the engine block in a co-joined cylinder (32). A crank case is located at the bottom of the engine block. The crank case houses the two crankshafts (11,12) with parallel axes in the direction of the longitudinal axis of the engine block. Two connecting rods (24) connect the pair of pistons (21,22) to the respective crankshafts (11,12). The pair of crankshafts (11,12) have interlocking gears to assist with the synchronization of the pistons (21, 22). FIG. 2 shows how the piston (21), connecting rod (24), and crankshaft (11) on one side of the engine's longitudinal axis are a mirror image of the second piston (22), connecting rod (24), and crankshaft (12) on the opposite side of the engine's longitudinal axis. The arrows indicate the upward movement of the two pistons (21, 22) during the compression stroke. This arrangement balances the engine.

As shown in FIG. 2, the co-joined combustion chamber (32) forms a compartment above the pair of pistons (21, 22). The combustion chamber (32) has an intake opening (30) and valve (38) which control the flow of air, or an air and fuel mixture, into the combustion chamber (32) during the intake stroke. The air/fuel mixture is ignited by cental spark plug (44). An exhaust valve (40) controls the withdrawal of exhaust gases from the combustion chamber (32) during the exhaust stroke.

During the intake stroke, fuel is injected into the air manifold (30) through a fuel injector (42). The fuel mixes with the combustion air producing a mixture of fuel and air. The fuel and air mixture is drawn into each combustion chamber (32) through the intake valve (38) when it is open. The exhaust valve (40) is closed during the intake stroke to prevent the fresh combustion air and injected fuel from escaping from the combustion chamber (32).

FIG. 3 depicts a cross-sectional view of the engine, with the two rear pistons (20, 23) and the two freewheeling mechanisms (26) mounted respectively on shafts (11) and (12). As indicated by the two arrows, the pistons (20,23) are moving downwardly and with valve (38) open and exhaust valve (40) closed, are drawing fuel from jet (42) and air into the combustion chamber (32) for later ignition by spark plug 44 at the top of the compressor stroke. A computerized governor (no drawing is shown because such governors are well known in the art) manages fuel consumption to the pistons. As shown in FIGS. 2 and 3, the forward and rear fuel injectors (42) drive pistons (21,22, 20 and 23) so that the engine provides full power to climb uphill, accelerate or operate under load. When the vehicle is travelling downhill, coasting or idling, the governor supplies fuel only to forward pistons (21, 22) so that the two rear pistons (20, 23), because of the freewheeling mechanisms (26), return to idle speed, which is approximately 500 rpm. Gears (25) synchronize the movement of the two rear pistons (20, 23) and other parts.

Specifically, with the freewheeling mechanism (26) installed on both crankshafts (11, 12) the forward two pistons (21, 22) driven by fuel injected in the front combustion chamber (32) can drive the two crankshafts (11, 12) and this action can be transferred via freewheeling mechanism (26) to the rear crankshaft (11, 12). However, when the vehicle driven by the engine is coasting or the engine is idling, fuel to rear chamber (32) driving piston (20, 23) is stopped and piston (20, 23) due to the freewheeling mechanism 26 can idle, thereby conserving fuel.

While the FIGS. 1 through 3 depict a gasoline powered engine, many of the same advantages can be realized for internal combustion engines using fuel other than gasoline. For example, for an engine using diesel as fuel, the diesel fuel can be injected directly into the combustion chamber (32) through an injector in the absence of a spark plug.

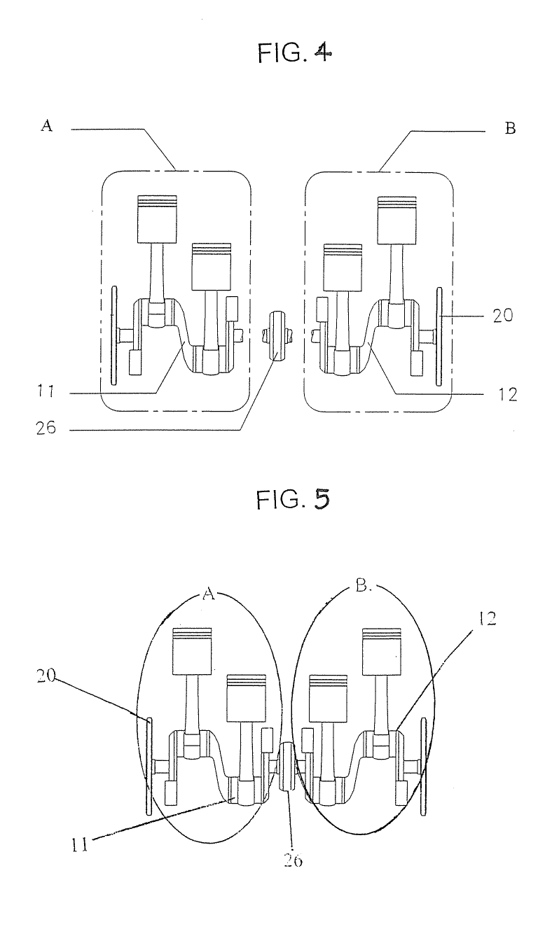

FIG. 4 illustrates an elevation view of two crankshafts (11,12), disconnected from but aligned in linear series with respective flywheels (20) at each end. FIG. 5 illustrates an elevation view similar to FIG. 4 with the engine components connected. The two crankshafts (11,12) have a freewheeling mechanism (26) positioned between them. The engine is started by starter (18) which rotates the rear flywheel (20). The freewheeling mechanism (26) enables crankshaft (12) and the connecting rods and pistons to idle when the vehicle is coasting downgrade or is stationary. When the vehicle is climbing upgrade, or accelerating, fuel is supplied to all pistons, the freewheeling mechanism (26) engages and both crankshafts (11,12) and the respective connecting rods and pistons provide full engine power.

FIG. 6, which appears on the same page as FIG. 1, illustrates an isometric view of two engines with respective freewheeling mechanisms connected to a crown and pinion gear assembly connected by axle to a vehicle wheel. As seen in FIG. 6, two engines 34 and 35 are connected by respective freewheeling mechanism 26 to a central crown and pinion gear which drives a wheel 37, such as a vehicle wheel. Engines 34 and 35 can be both powered, or one or the other can be powered, as the situation requires.

While two crankshafts are shown in the drawings it is understood that there can be three, four or more crankshaft connections, as required to fit various requirements. Also, while a four piston engine has been shown in FIGS. 1 to 3, it will be understood that further pistons, cylinders, and connecting rods can be added as required. The engine according to the invention is capable of making variable power generation in order to save gas, provide longer life, less wear and tear and less pollution.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A four stroke internal combustion engine comprising:
an engine block with at least two combustion chambers, corresponding pistons, connecting rods and first and second crankshafts;
a crank case associated with said engine block;
a first intake valve associated with the first cylinder;
a first exhaust valve associated with the first cylinder;
a second intake valve associated with the second cylinder;
a second exhaust valve associated with the second cylinder; and
a freewheeling mechanism installed between the first and second crankshafts, said freewheeling mechanism enabling the first crankshaft to drive the second crankshaft but the second crankshaft not to drive the first crankshaft.

2. The four stroke internal combustion engine of claim 1 further comprising an engine governor which controls supply of fuel to the first and second combustion chambers.

3. The four stroke internal combustion engine of claim 1 further comprising:
a first fuel injector associated with the first combustion chamber for injecting fuel directly into the first combustion chamber; and
a second fuel injector associated with the second combustion chamber for injecting fuel directly into the second combustion chamber.

4. The four stroke internal combustion engine of claim 1 wherein the first and second crankshafts are mounted in the crank case with parallel axes aligned with a longitudinal axis of the engine block, wherein the two crankshafts are geared to each other for synchronized counter-rotation by inter-locking teeth on gears mounted on the two crankshafts; and
rods connecting the two pistons to the two crankshafts whereby the unitary upward and downward movement of the pistons causes the two crankshafts to rotate.

5. The four stroke internal combustion engine of claim 1 wherein the first and second crankshafts are in a line and the freewheeling mechanism is positioned between the first and second crankshafts.

6. The four stroke internal combustion engine of claim 1 including two internal combustion engines with two respective freewheeling mechanisms which are connected to a crown and pinion combination for powering two axles with wheels at the ends of the two axles.
